(19) United States
(12) Patent Application Publication
(10) Pub. No.: US 2024/0036188 A1
(43) Pub. Date: Feb. 1, 2024

(54) PASSIVE TRANSPONDER, FLYING OBJECT AND METHOD FOR DETERMINING A POSITION OF AN OBJECT

(71) Applicant: Technische Universitat Dresden, Dresden (DE)

(72) Inventors: Martin LAABS, Dresden (DE); Dirk PLETTEMEIER, Dresden (DE)

(21) Appl. No.: 18/257,180

(22) PCT Filed: Dec. 15, 2021
(86) PCT No.: PCT/EP2021/085899

§ 371 Date: Jun. 13, 2023

(30) Foreign Application Priority Data
Dec. 18, 2020 (DE) 10 2020 134 160.1

(51) Int. Cl. G01S 13/75

(52) U.S. Cl. CPC G01S 13/75

(57) ABSTRACT

Disclosed herein are systems, methods, and devices for determining a position of an object using a passive transponder and a flying object (such as a satellite, drone, etc.). The passive transponder may be attached to an object to be located (such as a small animal, a bird, a good/product, etc.) and includes one or more antennas and a modulator configured to modulate a backscattering coefficient of the one or more antennas. The one or more antennas are configured to reflect at least a portion of a flying object signal transmitted from the flying object in response to the modulated backscattering coefficient in order to determine a position of the passive transponder using the reflected flying object signal.

### CROSS-REFERENCE TO RELATED APPLICATION(S)

This application is a national phase of PCT/EP2021/085899 filed on Dec. 15, 2021 that claims priority to German patent application No. 10 2020 134 160.1 filed on Dec. 18, 2020, the contents of both of which are incorporated fully herein by reference.

### TECHNICAL FIELD

Various embodiments relate to a passive transponder, a flying object, and a method for determining a position of an object.

### BACKGROUND

In general, objects may be located worldwide by means of various positioning systems. In doing so, it may be necessary to cover as large an area as possible (e.g. the surface of the Earth). In particular, for small objects and/or objects that may only carry a small mass (for example, small animals such as birds and insects), it may be necessary to provide a transponder that may be attached to these objects and a tracking system by means of which the position of the transponder may be determined. Furthermore, it may be necessary to distinguish between a plurality of objects to be located.

### BRIEF DESCRIPTION OF THE DRAWINGS

In the following description, various exemplary aspects of the disclosure are described with reference to the following drawings, in which:

FIGS. 1A and 1B each show a passive transponder according to various embodiments;

FIGS. 2A to 2F each show an exemplary tracking system according to various embodiments;

FIG. 3 shows an illustrative depiction of respective illumination zones according to various embodiments; and

FIG. 4 shows a method for determining a position of an object according to various embodiments.

### DESCRIPTION

In the following detailed description, reference is made to the accompanying drawings which form part thereof and in which are shown, by way of illustration, specific embodiments in which the invention may be practiced.

The term “processor” may be understood as any type of entity that allows processing of data or signals. For example, the data or signals may be handled according to at least one (i.e., one or more than one) specific function performed by the processor. A processor may comprise or be formed from an analogue circuit, a digital circuit, a mixed signal circuit, a logic circuit, a microprocessor, a central processing unit (CPU), a graphics processing unit (GPU), a digital signal processor (DSP), a programmable gate array (FPGA), an integrated circuit, or any combination thereof. Any other method of implementing the respective functions, described in more detail below, may also be understood to include a processor or logic circuit. It is understood that one or more of the method steps described in detail herein may be performed (e.g., implemented) by a processor, through one or more specific functions performed by the processor. Thus, the processor may be configured to perform any of the information processing methods described herein or components thereof.

In order to locate small objects (for example, small goods) and/or objects that may only carry a small mass (for example, small animals such as birds and insects), it may be necessary to provide a transponder that may be attached to these objects and/or may be attached according to regulations (e.g., in the case of small animals, a maximum weight of the transponder may be prescribed). Furthermore, it may be necessary to provide a tracking system by means of which the position of the transponder may be determined. Various embodiments relate to a passive transponder, a flying object, a tracking system, and a method for determining a position of an object by means of which a lightweight (e.g., having a mass of less than 1 g) passive transponder may be tracked (e.g., worldwide) using a flying object.

According to various embodiments, a passive transponder, a flying object, and a method for determining a position of an object are provided. In particular, a passive transponder, a flying object, and a method for determining a position of an object are provided, by means of which small objects and/or objects that may only carry a small mass may be located (e.g., globally located).

According to various embodiments, a passive transponder for attachment to an object to be located comprises: one or more antennas; a modulator configured to modulate a backscattering coefficient of the one or more antennas; wherein the one or more antennas are configured to reflect at least a portion of a flying object signal transmitted by the flying object based on the modulated backscattering coefficient such that a position of the passive transponder may be determined using the reflected flying object signal.

The passive transponder having the features of independent claim 1 forms a first example.

A passive transponder, as used herein, may be understood as a transponder that draws the energy required for communication (e.g., exclusively) from the field of the one or more antennas. Therefore, passive transponders may be powered by electromagnetic energy transmitted thereto. A passive transponder may be understood as a transponder which, for example, does not require its own power supply to transmit signals. For example, a passive transponder comprises no transmitting unit of its own and therefore no amplification of a signal to be transmitted takes place. In contrast, active transponders comprise their own power supply, such as a battery, or the active transponders are connected to a power grid. It is understood that a passive transponder may be designed as a battery-assisted passive transponder, which may comprise a battery as a power source, but does not comprise an active transmitting unit. Active transponders are conventionally used for long range data transmission, as the active amplification of the signal to be transmitted significantly increases the range.

However, active transponders have a significantly higher mass than passive transponders due to their own power supply and the transmitter unit with amplifier. Due to the lower weight of the passive transponder, the localization of a passive transponder described herein allows it to be attached to small objects and/or to objects that may only bear a small mass, thus enabling localization of these objects.

An object may be any object to which the passive transponder may be attached by means of one or more fasteners (e.g., a band, strap, clamp, adhesive, etc.). For example, an object may be a small animal, such as a bird or an insect, or a good, etc. Illustratively, active transponders, which comprise a significantly higher mass than passive transponders due to their own energy supply, are not suitable to be attached to a small animal, such as a bird or insect.

A flying object (also referred to in some aspects as a flying device) may be any type of object that may travel (e.g., fly, e.g., hover, e.g., glide) above the surface of the Earth (e.g., in the atmosphere, e.g., in space). For example, a flying object may be an airplane, helicopter, drone, balloon, satellite, etc.

The modulation of the backscatter cross-section described herein has the effect of allowing a very small passive transponder to be located by means of one or more flying objects.

It is noted that a plurality of modulators may be used. It is further noted that a radar reflector may be used in place of or in addition to the one or more antennas, and that the modulator may be configured to modulate a backscattering coefficient of the radar reflector as described herein with reference to the one or more antennas.

The flying object signal may be a modulated flying object signal. The feature described in this paragraph in combination with the first example forms a second example.

The modulated flying object signal may be a frequency modulated flying object signal and/or an encoded flying object signal. The feature described in this paragraph in combination with the second example forms a third example.

The passive transponder may comprise a mass of less than 1 g. The feature described in this paragraph in combination with one or more of the first example to the third example forms a fourth example.

This has the effect that the passive transponder may be attached to small objects and/or objects that may only carry a small mass, so that the position of these objects may be determined.

The passive transponder may comprise an energy source configured to provide electrical energy to the modulator. The energy source (e.g., battery, solar cell, other energy harvesting device) may be configured to have a life of at least 30 weeks. The features described in this paragraph in combination with one or more of the first example through the fourth example form a fifth example.

The modulator may be configured to periodically change the backscattering coefficient of the one or more antennas (e.g., a backscattering cross-section). The features described in this paragraph in combination with one or more of the first example through the fifth example form a sixth example.

The modulator may be configured to modulate the backscattering coefficient of the one or more antennas using frequency modulation. The features described in this paragraph in combination with one or more of the first example through the sixth example form a seventh example.

The modulator may be configured to modulate the backscattering coefficient of the one or more antennas such that the reflected flying object signal may be associated with the passive transponder using the modulation. The features described in this paragraph in combination with one or more of the first example through the seventh example form an eighth example.

The modulator may be configured to modulate the backscattering coefficient of the one or more antennas such that the reflected flying object signal has a frequency shift dependent on the modulated backscattering coefficients. The features described in this paragraph in combination with one or more of the first example through the eighth example form a ninth example.

A flying object for locating a passive transponder may comprise: a linear antenna array configured to receive a flying object signal reflected from a passive transponder; and one or more processors configured to determine a position of the passive transponder using a pulse compression method and/or an azimuth compression method of the received reflected flying object signal. The flying object having the features described in this paragraph forms a tenth example. Capturing the reflected flying object signal using a linear antenna array and applying a pulse compression method and/or an azimuth compression method to the received reflected flying object signal may enable passive transponders to be located by means of a flying object despite the comparatively long distance.

The flying object may move (e.g., travel) at a substantially constant speed. The features described in this paragraph in combination with the tenth example form an eleventh example.

The linear antenna array may comprise a plurality of antennas, each antenna of the plurality of antennas configured to receive the reflected flying object signal. The features described in this paragraph in combination with the tenth example or the eleventh example form a twelfth example.

A linear antenna array, as used herein, may refer to an antenna array in which all antennas of the antenna array are arranged along an axis (e.g., on a line). The antennas of the linear antenna array may be regularly spaced along the axis.

Each antenna of the plurality of antennas may be associated with a respective processing device of a plurality of processing devices. At least one processing device of the plurality of processing devices may be configured to process the reflected flying object signal received by the associated antenna and to determine an elevation angle of the passive transponder using a position of the flying object. The features described in this paragraph in combination with the twelfth example form a thirteenth example.

The at least one processing device may be configured to determine the elevation angle of the passive transponder using the position of the satellite and an illumination zone of the linear antenna array. The features described in this paragraph in combination with the thirteenth example form a fourteenth example.

Each processing device of the plurality of processing devices may be configured to determine a phase difference of the respective received reflected flying object signal. The one or more processors may be configured to determine an azimuth angle of the passive transponder using the phase differences determined by the plurality of processing devices and the position of the flying object. The features described in this paragraph in combination with one or more of the twelfth example through the fourteenth example form a fifteenth example.

The one or more processors may be configured to determine the azimuth angle of the passive transponder using the phase differences determined using the plurality of processing devices, the position of the flying object, and an illumination zone of the linear antenna array. The features described in this paragraph in combination with the fifteenth example form a sixteenth example.

The one or more processors may be configured to determine the azimuth angle of the passive transponder using the phase differences determined using the plurality of processing devices, the position of the flying object, the illumination zone of the linear antenna array, and a trajectory of the flying object. The features described in this paragraph in combination with the sixteenth example form a seventeenth example.

The one or more processors may be configured to determine the position of the passive transponder using the determined elevation angle and the determined azimuth angle of the passive transponder. The features described in this paragraph in combination with one or more of the thirteenth example or the fourteenth example and with one or more of the fifteenth example through the seventeenth example form an eighteenth example.

The flying object may be configured to perform a synthetic aperture radar procedure in the direction of flight of the flying object to determine the position of the passive transponder. The features described in this paragraph in combination with one or more of the tenth example through the eighteenth example form a nineteenth example.

Illustratively, a larger area (e.g., Earth's surface) is scanned in this manner over a sequence of sub-areas (e.g., defined by an illumination zone of the antenna array) over a period of time. For example, reflected signals of the flying object are detected over a continuous period of time.

The flying object may further comprise a transmitting antenna configured to transmit the flying object signal in the direction of the passive transponder. The features described in this paragraph in combination with one or more of the tenth example through the nineteenth example form a twentieth example.

At least one processing device of the plurality of processing devices may be configured to determine a frequency of the reflected flying object signal received by the associated antenna. The one or more processors may be configured to determine a Doppler shift of the reflected flying object signal using the determined frequency of the received reflected flying object signal and a frequency of the flying object signal transmitted by the transmitting antenna. The features described in this paragraph in combination with the twentieth example form a twenty-first example.

A tracking system may comprise one or more passive transponders according to one or more of the first example through the ninth example. The tracking system may comprise one or more flying objects according to one or more of the tenth example through the twenty-first example. The tracking system having the features described in this paragraph forms a twenty-second example.

The tracking system may further comprise another flying object configured to transmit the flying object signal in the direction of the one or more passive transponders. The features described in this paragraph in combination with the twenty-second example form a twenty-third example.

A method for determining a position of an object may comprise: reflecting at least a portion of a flying object signal transmitted by a flying object to a passive transponder attached to an object, the passive transponder comprising one or more antennas having a modulated backscatter cross-section (e.g., a modulated input impedance), such that the position of the object may be determined using the reflected flying object signal. The method having the features described in this paragraph forms a twenty-fourth example.

The method may further comprise: receiving the reflected flying object signal using a linear antenna array of the flying object; determining an elevation angle and an azimuth angle of the passive transponder using a pulse compression method and/or an azimuth compression method of the received reflected flying object signal and a position of the flying object; and determining the position of the object using the determined elevation angle and the determined azimuth angle. The features described in this paragraph in combination with the twenty-fourth example form a twenty-fifth example.

Determining the elevation angle and azimuth angle of the passive transponder using the received reflected flying object signal and the position of the flying object may comprise: determining the elevation angle and azimuth angle of the passive transponder using the received reflected flying object signal and the position of the flying object by means of digital beamforming. The features described in this paragraph in combination with the twenty-fifth example form a twenty-sixth example.

Receiving the reflected flying object signal using the flying object may comprise receiving the reflected flying object signal using the linear antenna array of the flying object, the linear antenna array comprising a plurality of antennas. Determining the elevation angle and azimuth angle of the passive transponder using the received reflected flying object signal and the position of the satellite using digital beamforming may comprise: processing the received reflected flying object signal by means of each processing device of a plurality of processing devices of the linear antenna array, each processing device of the plurality of processing devices being associated with an antenna of the plurality of antennas, wherein processing the received reflected flying object signal by a processing device may comprise: determining a phase difference of the received reflected flying object signal; and determining the elevation angle of the passive transponder using the position of the flying object. The method may comprise determining the azimuth angle of the passive transponder using the phase differences of the received reflected flying object signal determined by each processing device of the plurality of processing devices. The features described in this paragraph in combination with the twenty-fifth example or the twenty-sixth example form a twenty-seventh example.

Determining the elevation angle of the passive transponder using the position of the flying object may comprise: converting the received reflected flying object signal into a baseband signal; filtering the baseband signal using a pulse compression method and/or an azimuth compression method; filtering out a background echo signal from the baseband signal using a filtering method (e.g., time filtering method, frequency filtering method, a code domain filtering method); determining a distance between the flying object and the passive transponder using the filtered baseband signal; determining the elevation angle of the passive transponder using the position of the flying object and the distance between the flying object and the passive transponder. The features described in this paragraph in combination with the twenty-seventh example form a twenty-eighth example.

The method may further comprise: receiving the reflected flying object signal using another flying object; determining an elevation angle and an azimuth angle of the passive transponder using the received reflected flying object signal and a position of the other flying object; and determining the position of the object using the determined elevation angle and the determined azimuth angle. The features described in this paragraph in combination with one or more of the twenty-fourth example through the twenty-eighth example form a twenty-ninth example.

Determining the elevation angle and azimuth angle of the passive transponder using the received reflected flying object signal and the position of the other flying object may comprise: determining the elevation angle and azimuth angle of the passive transponder using the received reflected flying object signal and the position of the other flying object by means of digital beamforming. The features described in this paragraph in combination with the twenty-ninth example form a thirtieth example.

Receiving the reflected flying object signal using the other flying object may comprise receiving the reflected flying object signal using a linear antenna array of the other flying object, the linear antenna array comprising a plurality of antennas. Determining the elevation angle and azimuth angle of the passive transponder using the received reflected flying object signal and the position of the other flying object by means of digital beamforming may comprise: processing the received reflected flying object signal by each processing device of a plurality of processing devices of the linear antenna array, each processing device of the plurality of processing devices being associated with an antenna of the plurality of antennas, wherein processing the received reflected flying object signal by a processing device comprises: determining a phase difference of the received reflected flying object signal; and determining the elevation angle of the passive transponder using the position of the other flying object. The method may further comprise: determining the azimuth angle of the passive transponder using the phase differences of the received reflected flying object signal determined by each processing device of the plurality of processing devices. The features described in this paragraph in combination with the twenty-ninth example or the thirtieth example form a thirty-first example.

Determining the elevation angle of the passive transponder using the position of the other flying object may comprise: converting the received reflected flying object signal into a baseband signal; filtering the baseband signal using a pulse compression method and/or an azimuth compression method; filtering out a background echo signal from the baseband signal using a filtering method (e.g., time filtering method, frequency filtering method, e.g. a code domain filtering method); determining a distance between the other flying object and the passive transponder using the filtered baseband signal; determining the elevation angle of the passive transponder using the position of the other flying object and the distance between the other flying object and the passive transponder. The features described in this paragraph in combination with the thirty-first example form a thirty-second example.

A method for determining a respective position of a first object and a second object may comprise: modulating, by a first modulation, a backscattering coefficient (e.g.) of one or more first antennas associated with a first passive transponder, the first passive transponder being attached to a first object; modulating, by a second modulation, a backscattering coefficient (e.g. input impedance) of one or more second antennas associated with a second passive transponder, wherein the second passive transponder is attached to a second object, and wherein the first modulation of the backscattering coefficient of the first passive transponder is different from the second modulation of the backscattering coefficients of the second passive transponder; reflecting at the first passive transponder at least a portion of a flying object signal transmitted by a flying object and at the second passive transponder at least a portion of the transmitted flying object signal such that by means of the flying object signal reflected at the first passive transponder the position of the first object may be determined and that by means of the flying object signal reflected at the second passive transponder the position of the second object may be determined. The method having the features described in this paragraph forms a thirty-third example.

The flying object signal reflected at the first passive transponder may be mapped to the first passive transponder using the first modulation. The flying object signal reflected from the second passive transponder may be mapped to the second passive transponder using the second modulation. The features described in this paragraph in combination with the thirty-third example form a thirty-fourth example.

The method may further comprise: receiving the flying object signal reflected at the first passive transponder using a linear antenna array of the flying object; determining a first elevation angle and a first azimuth angle of the first passive transponder using a pulse compression method and/or an azimuth compression method of the received flying object signal reflected at the first passive transponder and a position of the flying object; determining the position of the first object using the determined first elevation angle and the determined first azimuth angle; receiving the flying object signal reflected at the second passive transponder using the linear antenna array of the flying object; determining a second elevation angle and a second azimuth angle of the second passive transponder using a pulse compression method and/or an azimuth compression method of the received flying object signal reflected at the second passive transponder and the position of the flying object; determining the position of the second object using the determined second elevation angle and the determined second azimuth angle. The features described in this paragraph in combination with the thirty-third example or the thirty-fourth example form a thirty-fifth example.

The method may further comprise: receiving the flying object signal reflected at the first passive transponder using a linear antenna array of another flying object; determining a first elevation angle and a first azimuth angle of the first passive transponder using a pulse compression method and/or an azimuth compression method of the received flying object signal reflected at the first passive transponder and a position of the other flying object; determining the position of the first object using the determined first elevation angle and the determined first azimuth angle;

receiving the flying object signal reflected at the second passive transponder using the linear antenna array of the other flying object; determining a second elevation angle and a second azimuth angle of the second passive transponder using a pulse compression method and/or an azimuth compression method of the received flying object signal reflected at the second passive transponder and the position of the other flying object; determining the position of the second object using the determined second elevation angle and the determined second azimuth angle. The features described in this paragraph in combination with the thirty-third example or the thirty-fourth example form a thirty-sixth example.

A method for determining a respective position of one or more objects of a plurality of objects, the method may comprise: for each passive transponder of a plurality of passive transponders, modulating a backscatter cross-section of one or more antennas associated with the passive transponder, wherein the modulation of the backscatter cross-section of each passive transponder is different from the modulation of the backscatter cross-section of the other passive transponders of the plurality of passive transponders, and wherein each passive transponder of the plurality of passive transponders is attached to an associated object of the plurality of objects; reflecting at least a respective portion of a flying object signal transmitted by a satellite at one or more passive transponders of the plurality of passive transponders such that the respective position of the one or more objects associated with the one or more passive transponders may be determined by means of the flying object signal reflected at the one or more passive transponders. The method having the features described in this paragraph forms a thirty-seventh example.

A computer program product may store program instructions which, when executed, execute the method according to one or more of the twenty-fourth example through the thirty-seventh example. The computer program product described in this paragraph forms a thirty-eighth example.

A computer program may store instructions that, when executed by a processor, cause the processor to perform a procedure according to one or more of the twenty-fourth example through the thirty-seventh example. The computer program described in this paragraph forms a thirty-ninth example.

A computer-readable medium may store instructions that, when executed by a processor, cause the processor to perform a method according to one or more of the twenty-fourth example through the thirty-seventh example. The computer-readable medium described in this paragraph forms a fortieth example.

A nonvolatile medium may store instructions that, when executed by a processor, cause the processor to perform a method according to one or more of the twenty-fourth example through the thirty-seventh example. The nonvolatile medium described in this paragraph forms a forty-first example.

A use of a passive transponder to attach to an object to be located for flying object-assisted location of the object forms a forty-second example. The passive transponder may comprise: one or more antennas; a modulator configured to modulate a backscattering coefficient of the one or more antennas; wherein the one or more antennas are configured to reflect at least a portion of a flying object signal transmitted by the flying object in response to the modulated backscattering coefficient.

The flying object may be configured in accordance with one or more of the tenth example to the twenty-first example. The feature described in this paragraph forms a forty-fourth example.

The passive transponder used may be a conventional passive transponder, such as a conventional passive RFID chip. For example, the passive transponder may comprise conventional receive/transmit technology. The features described in this paragraph in combination with the forty-second example or the forty-third example form a forty-fourth example.

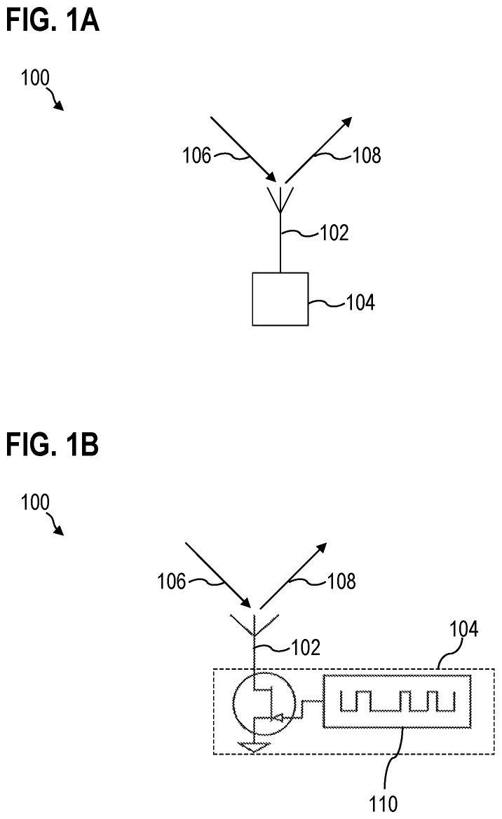

FIG. 1A and FIG. 1B illustrate a passive transponder 100 according to various embodiments. The passive transponder 100 may be configured to be attachable to an object (e.g., a small animal, such as a bird or an insect, e.g., a good, etc.).

The passive transponder 100 may comprise one or more antennas 102. The passive transponder 100 may comprise a modulator 104 (e.g., a modulation device). The modulator 104 may be configured to modulate a backscattering coefficient of the one or more antennas 102. According to various embodiments, modulating the backscattering coefficient may modulate a backscattering cross-section of the passive transponder 100. The modulator 104 may be configured to modulate the backscattering coefficient of the one or more antennas 102 such that the backscattering coefficient (and thus, for example, the backscattering cross-section) of the one or more antennas 102 is changed (e.g., periodically changed).

For example, the modulator 104 may be configured to modulate the backscattering coefficient of the one or more antennas 102 by modulating an input impedance of the one or more antennas 102. The modulator 104 may be configured to modulate the input impedance of the one or more antennas 102 using frequency modulation.

The one or more antennas 102 may be configured to reflect at least a portion of a flying object signal 106 (e.g., of an aircraft, e.g., of a helicopter, e.g., of a drone, e.g., of a balloon, e.g., of a satellite) sent from a flying object (e.g., flying object signal 106 sent toward the Earth) as a function of the modulated backscatter cross-section (e.g., the modulated input impedance) such that a position (e.g., a position on the surface, e.g., a three-dimensional position) of the passive transponder 100 may be determined by means of the reflected flying object signal 108. Illustratively, the one or more antennas 102 may be configured to reflect the flying object signal 106 such that the flying object signal 108 reflected by means of the one or more antennas 102 may be distinguished from a flying object signal reflected at the surface of the Earth. The flying object signal 106 may be, for example, a modulated flying object signal. For example, the modulated flying object signal may be a frequency modulated flying object signal (e.g., a frequency modulated continuous wave flying object signal). The modulated flying object signal may be, for example, an encoded flying object signal (see, for example, 110 in FIG. 1B). The modulated flying object signal may be a chirp signal whose frequency may vary with time. The modulated flying object signal may be a pulsed signal.

According to various embodiments, the passive transponder 100 may comprise a mass of less than 5 g (e.g., less than 4 g, e.g., less than 3 g, e.g., less than 2 g, e.g., less than 1 g).

According to various embodiments, the passive transponder 100 may comprise a power source. The energy source may be configured to provide electrical energy to the modulator 104. The power source may comprise a life span of at least 30 weeks (e.g., of more than 40 weeks, e.g., of more than 50 weeks, etc.). For example, the energy source may comprise a battery, a solar cell, and/or a device that uses energy harvesting.

The modulator 104 may be configured to modulate the backscattering coefficient (e.g., the input impedance) of the one or more antennas 102 such that the reflected flying object signal 108 has a frequency shift dependent on a modulation signal. The modulator 104 may be configured to modulate the backscattering coefficient of the one or more antennas 102 such that the reflected flying object signal 108 may be mapped to the passive transponder 100 using the modulation. Illustratively, the passive transponder 100 may be distinguished from other (e.g., passive) transponders using the modulation of the passive transponder 100. Further, the modulator 104 may be configured to modulate the backscattering coefficient of the one or more antennas 102 such that the flying object signal 108 reflected from the passive transponder 100 may be distinguished from other reflected signals (e.g., signals reflected from other objects, e.g., signals reflected from the surface of the Earth).

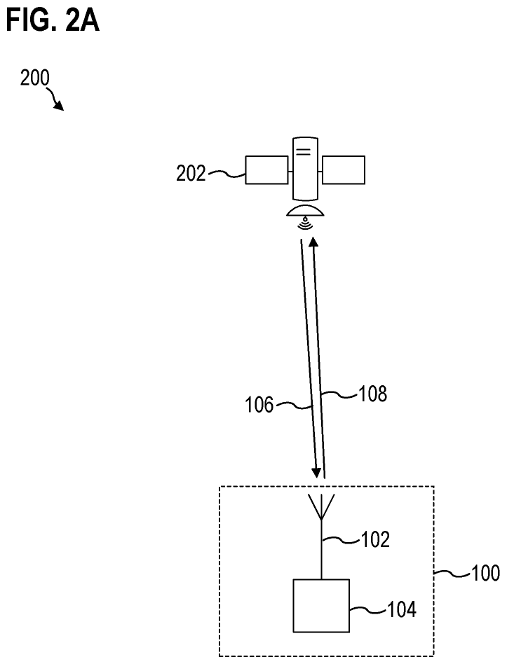

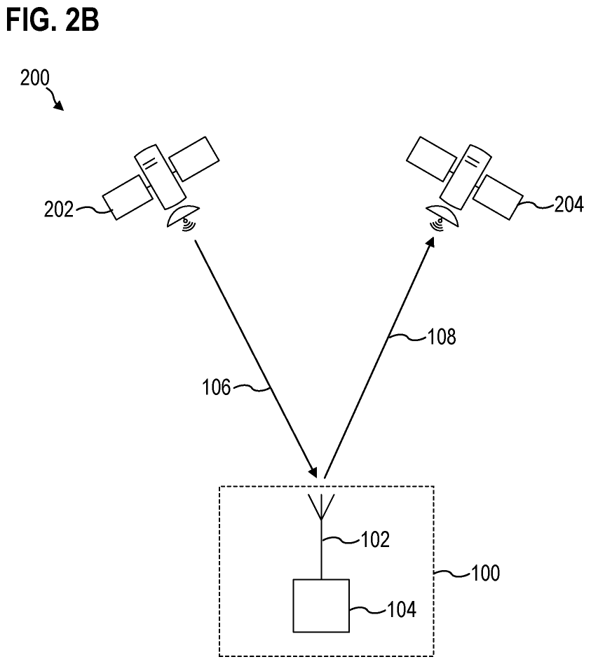

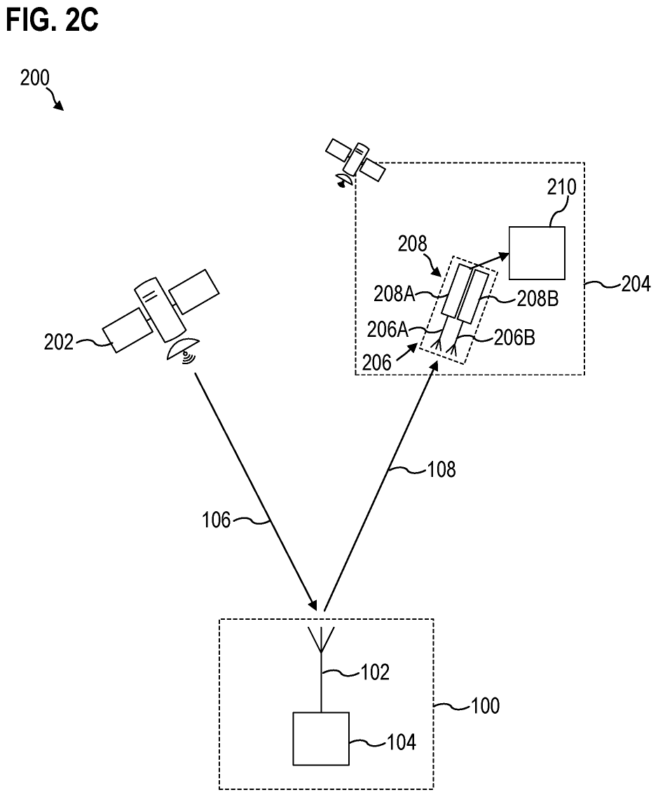

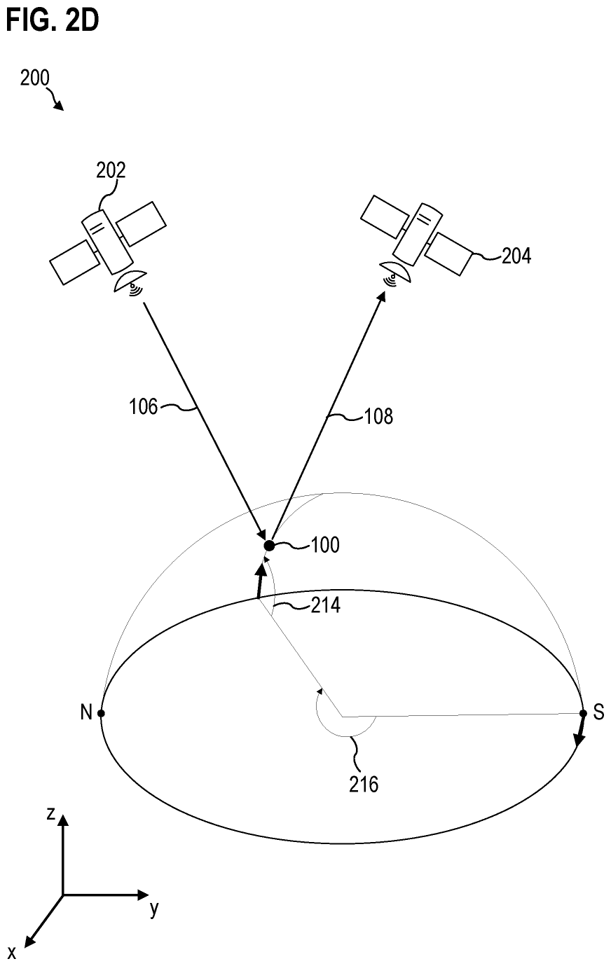

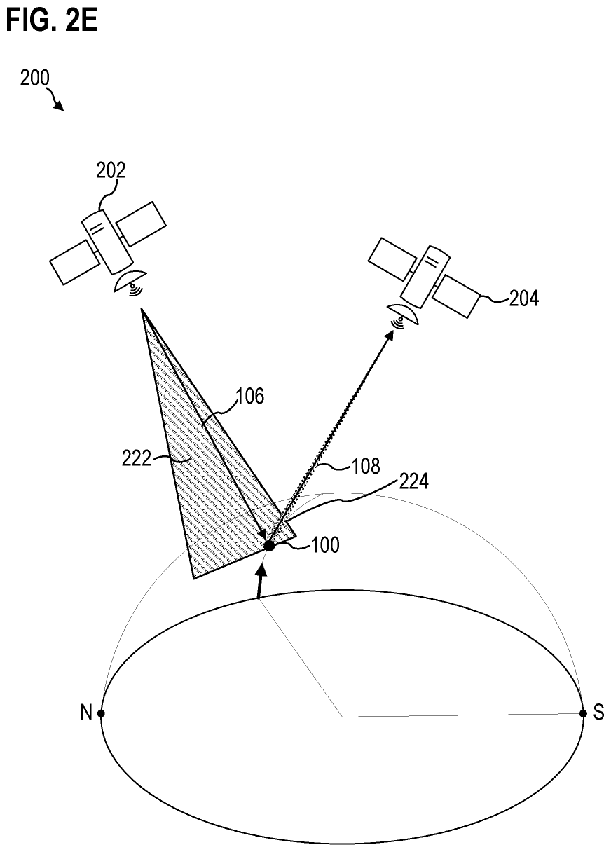

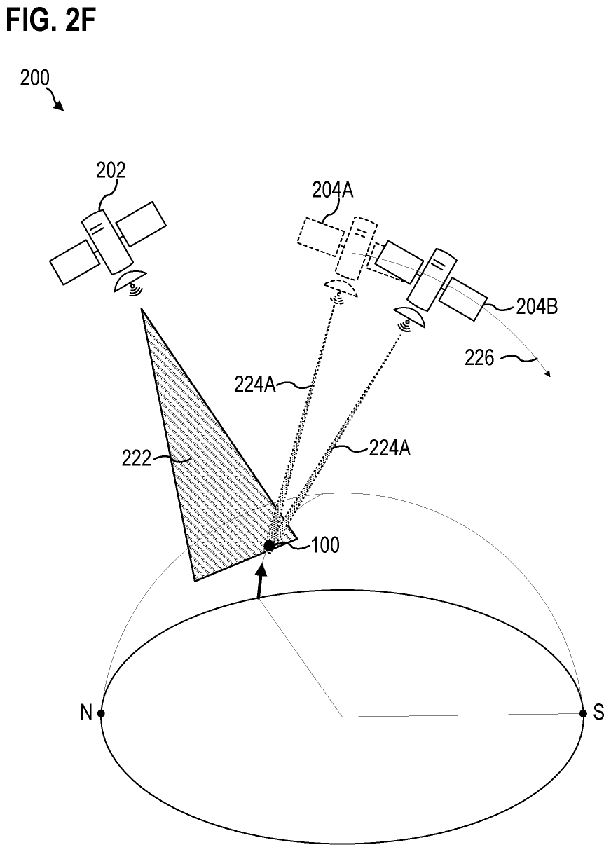

FIGS. 2A through 2F illustrate an exemplary tracking system 200 according to various embodiments. The tracking system 200 may comprise one or more passive transponders 100. The tracking system 200 may further comprise one or more flying objects (e.g., flying devices). The flying object may be a flying object for locating the one or more passive transponders 100. For example, the tracking system 200 may comprise a satellite 202 as the flying object.

In the following, the tracking system 200 is described with reference to a satellite as a flying object for illustrative purposes. It is noted that the satellite described with reference to the tracking system 200 may be any other type of flying object (e.g., a helicopter, e.g., an aircraft, e.g., a drone, e.g., balloon, etc.) that is capable of traveling (e.g., flying, e.g., hovering, e.g., gliding) above (e.g., at a distance from) the surface of the Earth (e.g., in the atmosphere, e.g., in space).

The satellite 202 may be configured to transmit the flying object signal 106. the satellite 202 may comprise a transmitting antenna. The transmitting antenna may be configured to transmit the flying object signal 106 in the direction of the passive transponder 100.

According to various embodiments, the satellite 202 may be configured to receive the reflected flying object signal 108 (see, for example, FIG. 2A). According to various embodiments, the tracking system 200 may further comprise another satellite 204. The other satellite 204 may be configured to receive the reflected flying object signal 108 (see, for example, FIG. 2B). The satellite 202 may be moving at a substantially constant speed. The other satellite 204 may be moving at a substantially constant speed.

Referring now to FIG. 2C, the satellite configured to receive the reflected flying object signal 108 (satellite 202 or satellite 204) is described illustratively. FIG. 2C depicts, for illustrative purposes, the reception of the reflected flying object signal 108 by the other satellite 204. However, it is noted that the first satellite 202 may also be so configured.

The other satellite 204 may comprise an antenna array. The antenna array may be, for example, a linear antenna array 206. The linear antenna array 206 may be, for example, a multiple input multiple output array antennas (MIMO) antenna. The linear antenna array 206 of the satellite 204 may be configured to receive a flying object signal 108 reflected from the passive transponder 100. The linear antenna array 206 may comprise a plurality of antennas, illustrated illustratively for antennas 206A and 206B. The plurality of antennas may be separate antennas, for example. Each antenna of the plurality of antennas may be configured to receive the reflected flying object signal 108. Illustratively, focusing on a direction may be achieved by means of coherent addition of the mutually delayed signals of the flying object received by the antennas of the plurality of antennas. The satellite 204 may comprise one or more processors 210. The one or more processors 210 may be configured to determine a position of the passive transponder 100 using the received reflected flying object signal 108.

The satellite 204 may comprise a plurality of processing devices 208. Each processing device of the plurality of processing devices 208 may be associated with a respective antenna of the plurality of antennas. For example, antenna 206A may have processing device 208A associated therewith. For example, antenna 206B may have processing device 208B associated therewith. Each processing device of the plurality of processing devices 208 may be configured to process the reflected flying object signal 108 received by the associated antennas. According to various embodiments, satellite 204 may use digital beamforming.

For illustrative purposes, the processing of the received reflected flying object signal 108 by a processing device and the one or more processors 210 is described with reference to FIG. 2D. FIG. 2D illustratively shows the tracking system 200 for locating the passive transponder 100 on (or above) the surface of the Earth. The Earth is indicated by north pole (N) and south pole (S).

At least one processing device of the plurality of processing devices 208 may be configured to process the reflected flying object signal 108 received from the associated antenna and determine an elevation angle 214 of the passive transponder 100. For example, each processing device of the plurality of processing devices 208 may be configured to process the reflected flying object signal 108 received from the associated antenna and determine a respective elevation angle 214 of the passive transponder 100. The one or more processors 210 may be configured to determine an average (e.g., arithmetic mean, e.g., median) of the determined elevation angles as the elevation angle 214 of the passive transponder 100. According to various embodiments, the at least one processing device of the plurality of processing devices 208 may be configured to process the reflected flying object signal 108 received from the associated antenna and determine the elevation angle 214 of the passive transponder 100 using a position of the satellite 204. According to various embodiments, a processing device may be configured to determine a frequency of the reflected flying object signal 108 received by the associated antennas. The one or more processors 210 may be configured to determine a Doppler shift of the reflected flying object signal 108 using the determined frequency of the received reflected flying object signal 108 and a frequency of the transmitted flying object signal 106 from the transmitting antenna (for example, the frequency of the transmitted flying object signal 106 may be known to the satellite 204, for example, information regarding the frequency of the transmitted flying object signal 106 may be communicated to the satellite 204). According to various embodiments, the one or more processors may determine a distance of the passive transponder 100 from the satellite 204 using the determined Doppler shift and the position of the satellite.

Each processing device of the plurality of processing devices 208 may be configured to determine a phase difference of the respective received reflected flying object signal 108. The one or more processors 210 may be configured to determine an azimuth angle 216 of the passive transponder 100 using the phase differences determined by the plurality of processing devices 208 and the position of the satellite 204.

According to various embodiments, the one or more processors 210 may be configured to determine the position of the passive transponder 100 using the determined elevation angle 214 and the determined azimuth angle 216 of the transponder 100.

FIG. 2E illustratively shows an illumination zone 222 of the transmitting antenna of satellite 202. Illustratively, the illumination zone 222 of the transmitting antenna of satellite 202 may be the area into which the flying object signal transmitted by satellite 202 is broadcast. The linear antenna array 206 of the other satellite 204 may comprise an illumination zone 224 (also referred to in some aspects as a footprint). It is noted that the illumination zone 222 of the transmitting antenna on the Earth's surface may be ellipsoidal, and that the illumination zone 224 of the linear antenna array 206 on the Earth's surface may be ellipsoidal.

According to various embodiments, the at least one processing device of the plurality of processing devices 208 may be configured to process the reflected flying object signal 108 received by the associated antenna and determine the elevation angle 214 of the passive transponder 100 using the position of the satellite 204 and the illumination zone 224 of the linear antenna array 206.

According to various embodiments, a processing device (e.g., a plurality of processing devices of the plurality of processing devices 208, e.g., each processing device of the plurality of processing devices 208) may convert the reflected flying object signal 108 received from the associated antenna into a baseband signal. For example, a processing device may comprise a mixer and may be configured to convert the received reflected flying object signal 108 into the baseband signal by means of mixing with the transmitted flying object signal 106. A processing device may be configured to filter the baseband signal using a pulse compression method and/or an azimuth compression method. A processing device may be configured to filter a background echo signal from the baseband signal (e.g., the baseband signal filtered using the pulse compression method and/or the azimuth compression method) using a filtering method (e.g., a time filtering method, e.g., a frequency filtering method, e.g., a code domain filtering method). A processing device may be configured to determine a distance between the satellite 204 and the passive transponder 100 using the filtered baseband signal. A processing device may be configured to determine the elevation angle 214 of the passive transponder 100 using the position of the satellite 2054 and the distance between the satellite 204 and the passive transponder 100.

According to various embodiments, the one or more processors 210 may be configured to determine the azimuth angle 216 of the passive transponder 100 using the phase differences determined using the plurality of processing devices 208, the position of the satellite 204, and the illumination zone of the linear antenna array 206. For example, the one or more processors 210 may be configured to determine the azimuth angle 216 of the passive transponder 100 using the determined phase differences, the position of the satellite 204, the illumination zone 224 of the linear antenna array 206, and the illumination zone 222 of the transmitting antenna. Illustratively, the position of the passive transponder 100 may be determined using an intersection of the illumination zone 224 of the linear antenna array 206 and the illumination zone 222 of the transmitting antenna.

According to various embodiments, the one or more processors 210 may be configured to determine a distance of the passive transponder 100 from the satellite 204 using the determined Doppler shift and the position of the satellite. The one or more processors 210 may be configured to determine an elevation angle 214 of the transponder 100 using the distance of the passive transponder 100 and the illumination zone 224 of the linear antenna array 206.

With reference to FIG. 2F, the satellite 204 may move along a trajectory 226. For example, the satellite 204 may move along the trajectory 226 with a substantially constant trajectory. For example, the satellite 204 may have a first position 204A at a first time point and a second position 204B at a second time point. For example, the second time point may be temporally after the first time point. The linear antenna array 206 may comprise a first illumination zone 224A at the first position 204A and a second illumination zone 224B at the second position 204A.

According to various embodiments, the satellite 204 may perform a synthetic aperture radar (SAR) procedure in the direction of flight of the satellite 204. For example, the satellite 204 may perform a SAR procedure in the direction of flight of the satellite 204 to determine the position of the passive transponder 100. Illustratively, the satellite 204 may receive a first reflected flying object signal at the first time at the first position 204A and a second reflected flying object signal at the second time at the second position 204B. The satellite 204 may process the first reflected flying object signal and the second reflected flying object signal, respectively, to form the reflected flying object signal 108, as described herein. Illustratively, the satellite 204 may move and scan an area defined by the illumination zone of the linear antenna array 206. Illustratively, satellite 204 may thus scan the surface of the Earth over time. If a flying object signal reflected from a passive transponder is received, satellite 204 may determine the position of the passive transponder, as described herein.

According to various embodiments, the one or more processors 210 may be configured to determine the azimuth angle 216 of the passive transponder 100 using the phase differences determined using the plurality of processing devices 208, the position of the satellite 204, the illumination zone 224 of the linear antenna array 206, and the trajectory 226 of the satellite 204.

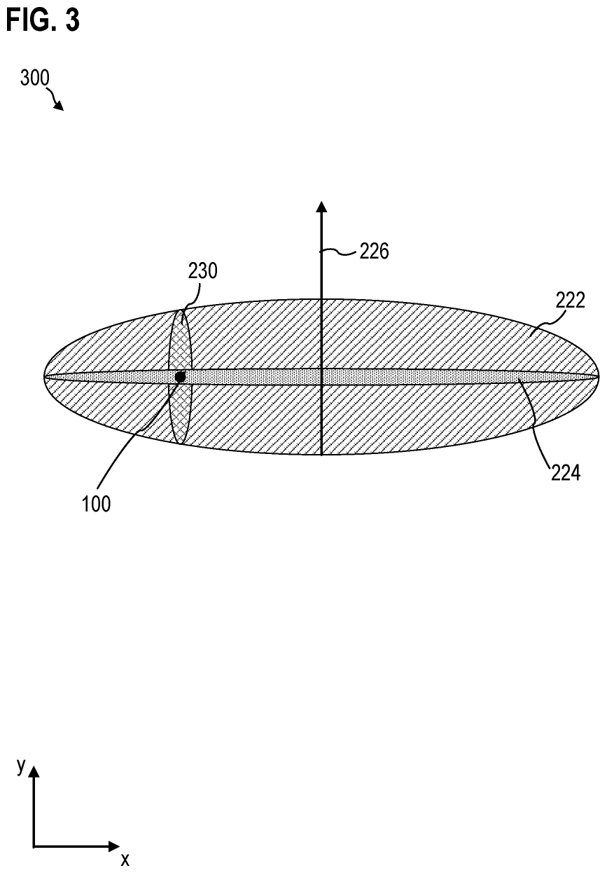

FIG. 3 shows an illustrative 2D representation of the illumination zone 222 of the transmit antenna of satellite 202 and the illumination zone 224 of the linear antenna array 206 of the other satellite 204, according to various embodiments. As described herein, one or more processing devices of the plurality of processing devices 208 may be configured to determine the elevation angle 214 of the passive transponder 100. According to various embodiments, the one or more processors 210 may determine an angle of incidence of the received reflected flying object signal 108 with respect to the linear antenna array 206 using the phase differences determined by the plurality of antennas of the linear antenna array 206. Using the determined angle of incidence, the azimuth range in which the passive transponder 100 may be located may be limited to, for example, the range 230 (illustrated illustratively with respect to the illumination zone 222). According to various embodiments, azimuth angle 216 of passive transponder 100 may be determined using the determined angle of incidence and illumination zone 224 of linear antenna array 206. Illustratively, azimuth angle 216 of passive transponder 100 may be determined as the intersection of region 230 and illumination zone 224.

The combination of the linear antenna array and applying the pulse compression method and/or the azimuth compression method to the received reflected flying object signal may allow passive transponders to be located at a much greater distance, so that, for example, a flying object may be used to locate passive transponders.

According to various embodiments, the tracking system 200 may comprise a first passive transponder and a second passive transponder. For example, the first passive transponder may be attached to a first object. The second passive transponder may be attached to a second object different from the first object. The first passive transponder may be substantially the same as the passive transponder 100, wherein the backscattering coefficient of the one or more antennas of the first passive transponder is modulated using a first modulation. The second passive transponder may be substantially the same as the passive transponder 100, wherein the backscattering coefficient of the one or more antennas of the second passive transponder is modulated using a second modulation different from the first modulation.

According to various embodiments, at least a portion of the flying object signal 106 transmitted by the transmitting antenna of the satellite 202 may be reflected at the first passive transponder. According to various embodiments, at least a portion of the flying object signal 106 transmitted by the transmitting antenna of the satellite 202 may be reflected at the second passive transponder.

The linear antenna array 206 of the other satellite 204 may be configured to receive the reflected flying object signal at the first passive transponder, and the other satellite 204 may determine the position of the first passive transponder as described herein for the reflected flying object signal 108. In doing so, the other satellite 204 may associate the reflected flying object signal with the first passive transponder using the first modulation. The linear antenna array 206 of the other satellite 204 may be configured to receive the flying object signal reflected from the second passive transponder, and the other satellite 204 may determine the position of the second passive transponder as described herein for the reflected flying object signal 108. In doing so, the other satellite 204 may associate the reflected flying object signal with the second passive transponder using the second modulation.

According to various embodiments, the tracking system 200 may comprise a plurality of passive transponders. Each passive transponder of the plurality of passive transponders may be associated with (e.g., attached to) a respective object. Each passive transponder of the plurality of passive transponders may substantially correspond to the passive transponder 100, wherein the modulation of the respective antennas of one or more passive transponders of the plurality of passive transponders is different from the modulation of the respective antennas of the other passive transponders of the plurality of passive transponders. For example, the passive transponders of the plurality of passive transponders may be classified into different groups and/or classes, and each group or class may comprise a modulation of the antennas of the respective passive transponders that is different from the other groups/classes. For example, a received reflected flying object signal may thus be assigned to a group and/or class. As an illustrative example, different types of birds may be distinguished in this way, for example, provided that each type of bird is assigned to a respective modulation.

According to various embodiments, the modulation of the respective antennas of each passive transponder of the plurality of passive transponders may be different from the other passive transponders of the plurality of passive transponders. Illustratively, using the respective modulation, each received flying object signal reflected from a passive transponder may be uniquely associated with a passive transponder of the plurality of passive transponders.

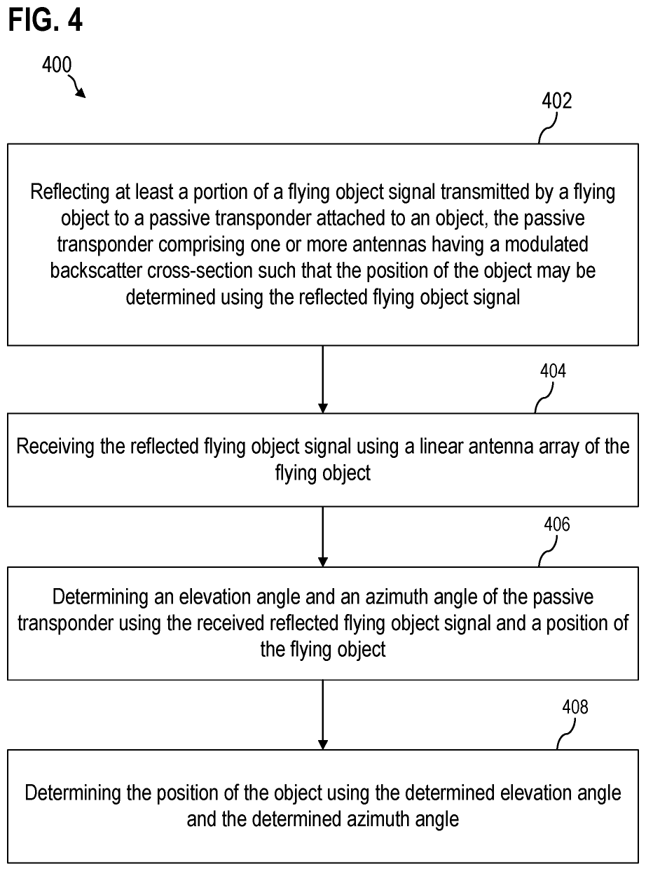

FIG. 4 illustrates a method 400 for determining a position of an object according to various embodiments.

The method 400 may include reflecting at least a portion of a signal of a flying object transmitted from the flying object to a passive transponder attached to the flying object, the passive transponder comprising one or more antennas having a modulated backscattering coefficient (e.g., a modulated backscattering cross-section), such that the reflected flying object signal may be used to determine the position of the flying object (in 402).

Optionally, the method 400 may further comprise receiving the reflected flying object signal using a linear antenna array of the flying object (at 404).

The method 400 may comprise determining an elevation angle and an azimuth angle of the passive transponder using the received reflected flying object signal (e.g., using pulse compression and/or azimuth compression) and a position of the flying object (in 406).

The method 400 may comprise determining the position of the object using the determined elevation angle and the determined azimuth angle (in 408).

According to various embodiments, the method 400 may further comprise identifying the object using the reflected flying object signal and the modulated backscattering coefficient of the passive transponder. Illustratively, the modulated backscattering coefficient and, as a result, the reflected flying object signal may be transponder specific.

1. A passive transponder for attachment to an object to be located, the passive transponder comprising:
one or more antennas; and
a modulator configured to modulate a backscattering coefficient of the one or more of antennas,
wherein the one or more antennas are configured to reflect at least a portion of a flying object signal transmitted by a flying object as a function of the modulated backscattering coefficient such that a position of the passive transponder can be determined based on the reflected portion of the flying object signal.

2. The passive transponder according to claim 1,
wherein the transmitted flying object signal is a frequency modulated flying object signal or an encoded flying object signal.

3. The passive transponder according to claim 1,
wherein the passive transponder comprises a mass of less than 1 g.

4. The passive transponder according to claim 1,
wherein the modulator is configured to modulate the backscattering coefficient of the one or more antennas using frequency modulation.

5. The passive transponder according to claim 1,
wherein the modulator is configured to modulate the backscattering coefficient of the one or more antennas such that the reflected portion of the flying object signal can be mapped to the passive transponder using the modulation.

6. A flying object for locating a passive transponder, the flying object comprising:
a linear antenna array configured to receive a flying object signal transmitted by the flying object or another flying object and reflected from a passive transponder; and
one or more processors configured to determine a position of the passive transponder using the received reflected flying object signal by a pulse compression method or an azimuth compression method.

7. The flying object according to claim 6,
wherein the linear antenna array comprises a plurality of antennas, each antenna of the plurality of antennas configured to receive the reflected flying object signal,
wherein each antenna of the plurality of antennas is associated with a respective processing device of a plurality of processing devices, and wherein at least one processing device of the plurality of processing devices is configured to process the reflected flying object signal received by its associated antenna and to determine an elevation angle of the passive transponder using a position of the flying object and an illumination zone of the linear antenna array.

8. The flying object according to claim 6,
wherein each processing device of the plurality of processing devices is configured to determine a phase difference of the respective received reflected flying object signal,
wherein the one or more processors are configured to determine an azimuth angle of the passive transponder using the phase differences determined by the plurality of processing devices, the position of the flying object, and an illumination zone of the linear antenna array.

9. The flying object according to claim 8,
wherein the one or more processors are configured to determine the azimuth angle of the passive transponder using the phase differences determined by the plurality of processing devices, the position of the flying object, the illumination zone of the linear antenna array, and a trajectory of the flying object.

10. The flying object according to claim 7,
wherein the one or more processors are configured to determine the position of the passive transponder using the determined elevation angle and the determined azimuth angle of the passive transponder.

11. The flying object according to claim 6,
wherein the flying object is configured to perform a synthetic aperture radar procedure in the direction of flight of the flying object to determine the position of the passive transponder.

12. A method for determining a position of an object, the method comprising:
reflecting at least part of a flying object signal transmitted by a flying object at a passive transponder attached to an object, which comprises one or more antennas with a modulated backscattering coefficient, in such a way that the position of the object can be determined by means of the reflected flying object signal.

13. The method according to claim 12, further comprising:
receiving the reflected flying object signal using a linear antenna array of the flying object, the linear antenna array comprising a plurality of antennas;
processing the received reflected flying object signal by each processing device of a plurality of processing devices of the linear antenna array, each processing device of the plurality of processing devices being associated with an antenna of the plurality of antennas, wherein the processing of the received reflected flying object signal is by a processing device and comprises:
determining a phase difference of the received reflected flying object signal; and
determine the elevation angle of the passive transponder using the position of the flying object;
determining the azimuth angle of the passive transponder using the phase differences of the received reflected flying object signal determined by each processing device of the plurality of processing devices; and
determining the position of the object using the determined elevation angle and the determined azimuth angle.

14. (canceled)

15. (canceled)

16. The flying object according to claim 7, wherein the at least one of the plurality of processing devices is configured to determine a frequency of the received reflected flying object signal.

17. The flying object according to claim 16, wherein the at least one of the plurality of processing devices is configured to determine a Doppler shift of the reflected flying object signal based on the determined frequency of the received reflected flying object signal.

18. The flying object according to claim 17, the flying object further comprising a transmitting antenna configured to transmit the flying object signal toward the passive transponder.

19. The flying object according to claim 18, wherein the at least one of the plurality of processing devices is configured to determine the Doppler shift of the reflected flying object signal further based on the transmitted flying object signal of the transmitting antenna.
